(19) United States
(12) Patent Application Publication
(10) Pub. No.: US 2007/0177394 A1
(43) Pub. Date: Aug. 2, 2007

(54) FLICKERING DISPLAY SYSTEMS AND METHODS

(76) Inventors: Curtis A. Vock, Niwot, CO (US); Perry Youngs, Longmont, CO (US); Adrian Larkin, Essex (GB)

Correspondence Address: LATHROP & GAGE LC, 4845 PEARL EAST CIRCLE, SUITE 300, BOULDER, CO, 80301, US

(21) Appl. No.: 11/623,217

(22) Filed: Jan. 15, 2007

Related U.S. Application Data
(60) Provisional application No. 60/758,741, filed on Jan. 13, 2006.

(51) Int. Cl. F21V 35/00

(52) U.S. Cl. 362/392; 362/569

(57) ABSTRACT

A flickering display system has: a display, a microprocessor, one or more light emitting diodes and digital memory, the memory storing one or more digital images of a lighted candle. Under control of the microprocessor, the digital images are displayed on the display and the diodes activate in a flame area of the candle such that, when viewed, the digital images and diodes appear like a real candle. Optionally the system includes an aroma generator that produces a scent similar to the scent produced when burning a scented candle.

### RELATED APPLICATION

This application claims priority to U.S. Patent Application Ser. No. 60/758,741, filed Jan. 13, 2006, the disclosure of which is incorporated herein by reference.

### BACKGROUND

Candles are widely used around the world to add color, movement and light to a room. Candles come in assorted types, so as to mount a candle on a table, within a candle-holder, or many other locations. Candles are also decorative items, often colored and marked with holiday-specific designs.

At the same time, candles are single-use items: they burn out and are thrown away. Candles are also dangerous, creating risk of fire within the household.

### SUMMARY

In an embodiment, a flickering display system has: a display, a microprocessor, one or more light emitting diodes and digital memory, the memory storing one or more digital images of a lighted candle, wherein, under control of the microprocessor, the display displays the digital images and the diodes activate in a flame area of the candle such that, when viewed, the digital images and diodes appear like a real candle.

In an embodiment, a method generates an appearance of a candle, by: generating an image of the candle on an LCD display; and utilizing one or more LEDs to brighten a flame area of the candle.

In an embodiment a scented flickering display system, has: a display, a microprocessor, one or more light emitting diodes, an aroma generator and digital memory, the memory storing one or more digital images of a lighted candle, wherein, under control of the microprocessor, the display displays the digital images and the diodes activate in a flame area of the candle such that, when viewed, the digital images and diodes appear like a real candle, and the aroma generator, under control of the microprocessor, generates a scented candle aroma.

### BRIEF DESCRIPTION OF THE FIGURES

FIG. 1 shows a schematic view of a flickering display system in accord with an embodiment.

FIG. 2 illustrates a candle as displayed on the system of FIG. 1.

FIG. 3 illustrates an exemplary arrangement of diodes in the system of FIG. 1.

FIG. 4 shows a flowchart illustrating one exemplary process for displaying a flickering image.

FIG. 5 shows part of a display system including a partial liquid crystal display (LCD) panel that is displaying a digital image sequence illuminated by one or more light emitting diodes (LEDs).

FIG. 6 shows a cross section through the partial display system of FIG. 5.

FIG. 7 shows one exemplary scented candle device that includes a frame, an LCD panel displaying an image of a candle and an aroma generator.

### DETAILED DESCRIPTION

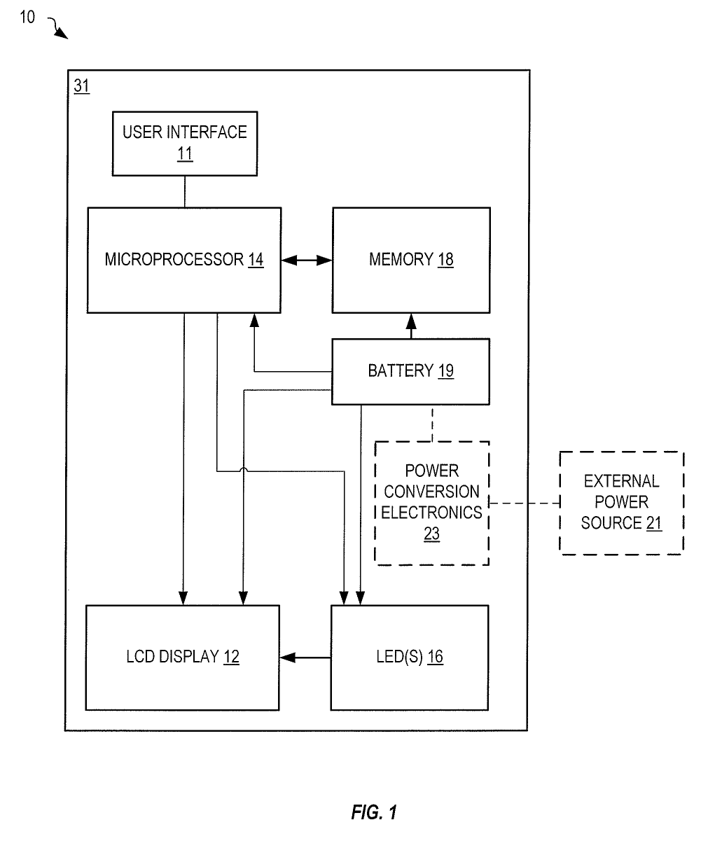

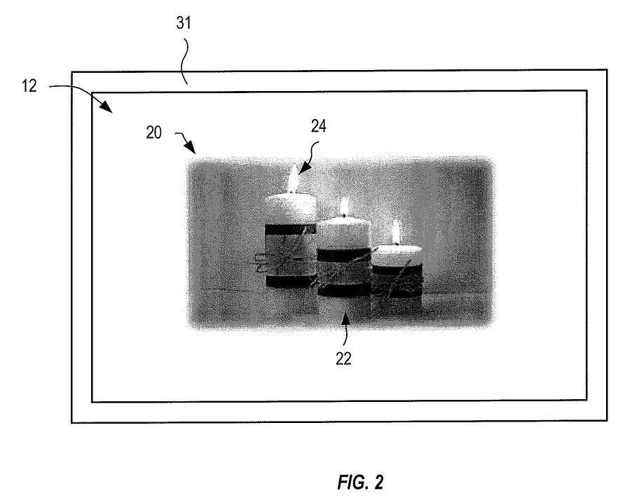

FIG. 1 shows one flickering display system 10. FIG. 2 illustrates how an image of a candle may be displayed by system 10. FIG. 1 and FIG. 2 are best viewed together with the following description. System 10 has a display 12, a microprocessor 14, one or more light emitting diodes (LEDs) 16 and digital memory 18. Memory 18 stores one or more digital images 20 of one or more lighted candles 22, wherein, under control of microprocessor 14, display 12 displays digital images 20 and LEDs 16 activate in flame area(s) 24 of candles 22 such that, when viewed, digital images 20 and LEDs 16 appear like one or more real candles. For example, flickering display system 10, through use of LEDs 16, may produce soft ambient lighting without the danger of an open flame. System 10 is also shown with a user interface 11 that provides control of functions of device 10. In one embodiment, user interface 11 is a switch that allows system 10 to be turned on and off. In another example, user interface 11 allows selection of different modes of operation of system 10.

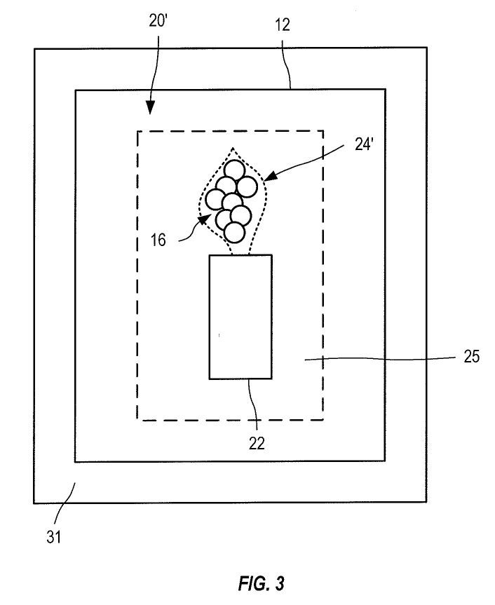

FIG. 3 illustrates an arrangement of LEDs 16 that may be used to produce flame of a single image candle 22. Specifically, in flame area 24′, a plurality of LEDs 16 are shown. LEDs 16 may be white light emitting diodes and modulated on and off by microprocessor 14 to provide flicker and appearance of a real flame. In an embodiment, LEDs 16 are positioned behind (i.e., opposite to the viewing side of display 12) display 12, which is for example an LCD display. Microprocessor 14 then may modulate pixels of display 12 in order to dim, brighten and/or flicker the appearance of LEDs 16 when activated by microprocessor 14.

Accordingly, display 12 has a front viewing surface 25 that the user views to see digital images, e.g., a digital movie. LEDs 16 may therefore mount to a back-side of display 12 and generate light, under control of microprocessor 12, to provide enhanced illumination to the front viewing surface 25. By way of example, display 12 may be partially transmissive to the light so that LEDs 16 provide backlighting to the digital images (e.g., to provide flickering of flame in flame area 24). LEDs 16 may be configured to provide high intensity light at a critical part of the digital image(s), for example to correspond to the flame within flickering candle 22. Under control of microprocessor 14, LEDs 16 and display 12 cooperate to provide “flickering” illumination of the candle for the user's viewing pleasure. When operationally viewed, the digital images of the flickering candle thus appear like a candle, with a flickering flame and candle body. See, e.g., FIG. 2. In one embodiment, the images are part of a movie (e.g., MPEG) wherein the candle body melts, over time, and shortens, like a real candle; except that display system 10 imitates these body-changing features through image display files (e.g., MPEG). In one example, the display may depict molten candle wax flowing down the side of the candle.

When display 12 is an LCD display that has a plurality of pixels forming the digital images on the front viewing surface, microprocessor 14 may be programmed to modulate at least some of the pixels to modify the flickering display. For example, microprocessor 14 may modulate the pixels to increase or decrease the intensity of light emitted by LEDs 16 and transmitted through display 12, so as to dim and alternatively increase the illumination of the flickering candle. The pixels of the front viewing surface may thus be modulated to make the flame of the candle appear to be flickering and moving on the front viewing surface.

Alternative configurations are within the scope of this document. For example, in one embodiment, the flame area 24 of the front viewing surface is not formed by digital image(s) but rather by a combination of modulating LCD pixels and LEDs 16 under control of microprocessor 14. In another embodiment, the images form a digital movie that is displayed on display 12 and coordinated with modulating LCD pixels and LEDs 16 to generate the candle flame. In still another embodiment, the light intensity of LED emissions is modulated by microprocessor 14 to control light intensity of the front viewing surface, particularly around the candle flame.

The power supply is for example a battery 19. A user may replace the battery as needed. However, battery 19 may be omitted and power converting electronics 23 included such that power may be supplied to device 10 by an external power source 21 (e.g., a household 120V supply), for example.

Display system 10 may include a frame 31 that is constructed and arranged to hold the display (and/or to support components of system 10), where front viewing surface 25 appears within frame 31. In this way, a user may mount display system 10 on a wall of the house, much like any other picture frame. A switch or wireless remote control may be used to activate display system 10 to display the recorded digital movie, e.g., a flickering candle that appears like any other candle except that it is synthetically created. Optionally, display system 10 may include a reset button that restarts the digital movie. For example, where the digital movie displays a candle burning down, the reset button may restart the display sequence, effectively restoring the candle display to its least burnt state.

Display 12 may be a plasma display. In this embodiment, the power supply is typically an AC power connector (not shown) that plugs the display system into regular house power (e.g., 120V). The plasma display uses the house power to drive the display, under control of microprocessor 14. Such a display system using the plasma display does not necessarily include LEDs 16, since the plasma display is self-illuminating.

Display system 10 may store a plurality of digital movies, each selectable by the user for viewing on the display. For example, images other than candles are within the scope of this document. For example, the images may be a hummingbird or other pleasant image. In an embodiment, display system 10 also stores sound files (e.g., WAV formatted digital files) within memory (e.g., memory 18 or other memory). In this embodiment, a speaker connects with display system 10 and generates music and/or other digital sounds under control of microprocessor 14. The digital movie may, for example, show a bush with a flying bee around the bush, wherein the sound files provide bee sounds. Those skilled in the art should appreciate that other digital movie and sound file combinations are within the scope of this document. For example, each digital movie may have a plurality of image sequences that may be selected and played at random to make the displayed image less predictable and thus more intriguing.

B&W, colored and/or white light LEDs may also be employed. In one embodiment, a polarizer is employed to modulate throughput of the LEDs in combination with the LCD display.

In an embodiment, digital images 20 includes a plurality of image sequences that may be selected at random for display on display 12 by microprocessor 14. For example, a first sequence may depict a steadily burning flame, a second sequence may depict a gently flickering flame and a third sequence may depict a strongly flickering flame. By selecting and displaying each sequence randomly, a realistic candle flame may be depicted. The random selection may be weighted such that the steady image occurs more than the gently flickering image that in turn occurs more often than the strongly flickering image.

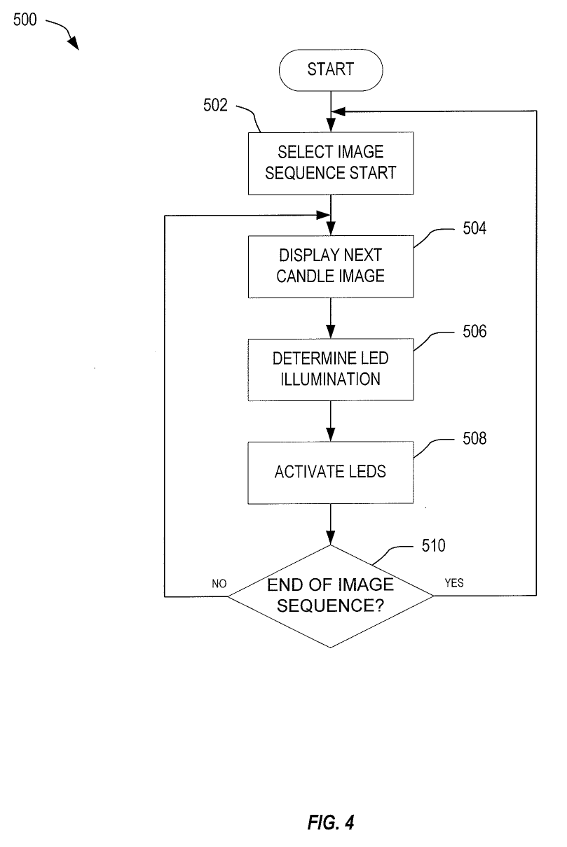

FIG. 4 shows a flowchart illustrating one exemplary process 500 for displaying a flickering image. Process 500 may, for example, operate within microprocessor 14, FIG. 1, to display digital images 20 on display 12 and to control LEDs 16. In step 502, process 500 selects the start of the image sequence to display. For example, microprocessor 14 may select a first frame of a first digital sequence within digital images 20. In step 504, process 500 displays the next image of the sequence. For example, microprocessor 14 may display the digital image on display 12. In step 506, process 500 determines LED illumination. In one example of step 506, microprocessor 14 utilizes a table within memory 18 that correlates LED 16 illumination options with the displayed image, based upon image sequence number, to determine brightness for each of LEDs 16. In step 508, process 500 activates LEDs (some or all of the LEDs). In one example of step 508, microcontroller 14 activates certain LEDs 16 based upon step 506. Step 510 is a decision. If, in step 510, the end of the imaging sequence is reached, process 500 continues with step 502; otherwise process 500 continues with step 504 to continue displaying images from the image sequence.

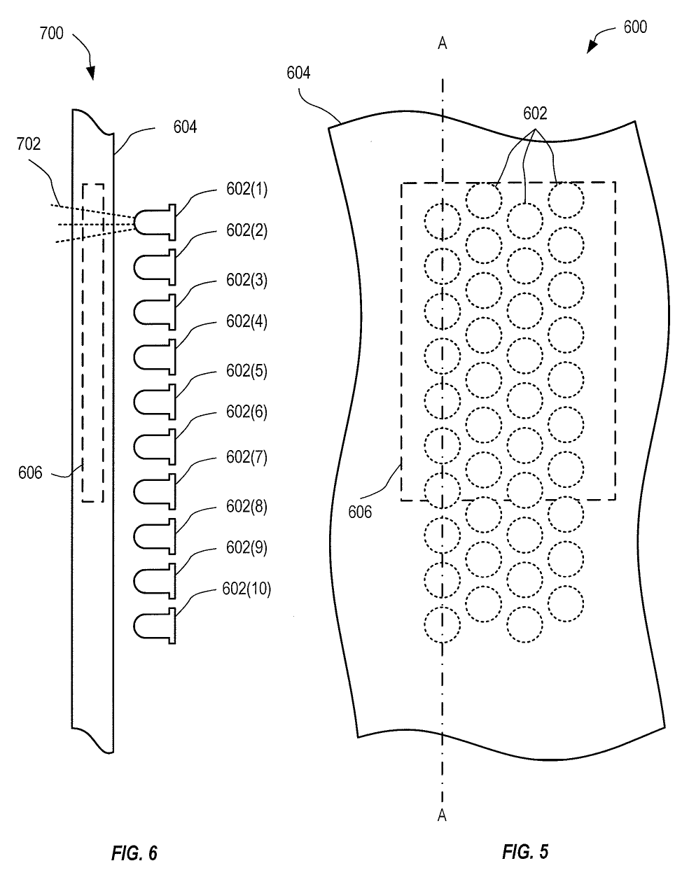

FIG. 5 shows a partial display system 600 including a partial LCD panel 604 that is displaying a digital image sequence 606 and a plurality of LEDs 602 (formed as an array of LEDs) that are positioned behind LCD panel 604. When activated, LEDs 602 transmit light through LCD panel 604 and digital image sequence 606, to enhance the effect of a burning flame. LCD panel 604 may represent LCD panel 12, FIG. 1; digital image sequence 606 may represent playing of digital images 20; LEDs 602 may represent LEDs 16. FIG. 6 shows a cross section 700 through partial display 600, as indicated as section A-A in FIG. 6, showing LEDs 602(1)-602(10) and digital image sequence 606 within LCD panel 604. LEDs 602 may be of same color, such as yellow or white; or LEDs 602 may be multicolored (e.g., red and yellow) and controlled, via the microprocessor, to produce a desired color and effect. LCD panel 604 may thus be monochrome, and LEDs 602 colored, to produce the desired colored effect in combination with LCD panel 604. Alternatively, LCD panel 604 itself may have color capability so that LEDs 602 may typically generate one color (e.g., white or yellow).

LEDs 602 may be placed at least partially within LCD panel 604, in an embodiment; that is, instead of placing LEDs 602 behind panel 604, they are integrated to a cut-away region (e.g., to accommodate the LED array or even each LED separately) of panel 604.

In an example of operation, digital image sequence 606 illustrates the flame of a flickering candle and LEDs 602 are simultaneously controlled (e.g., by microprocessor 14) to produce a realistic flame effect in that candle. Digital image sequence 606 and LEDs 602 thus cooperate to produce the desired flame effect.

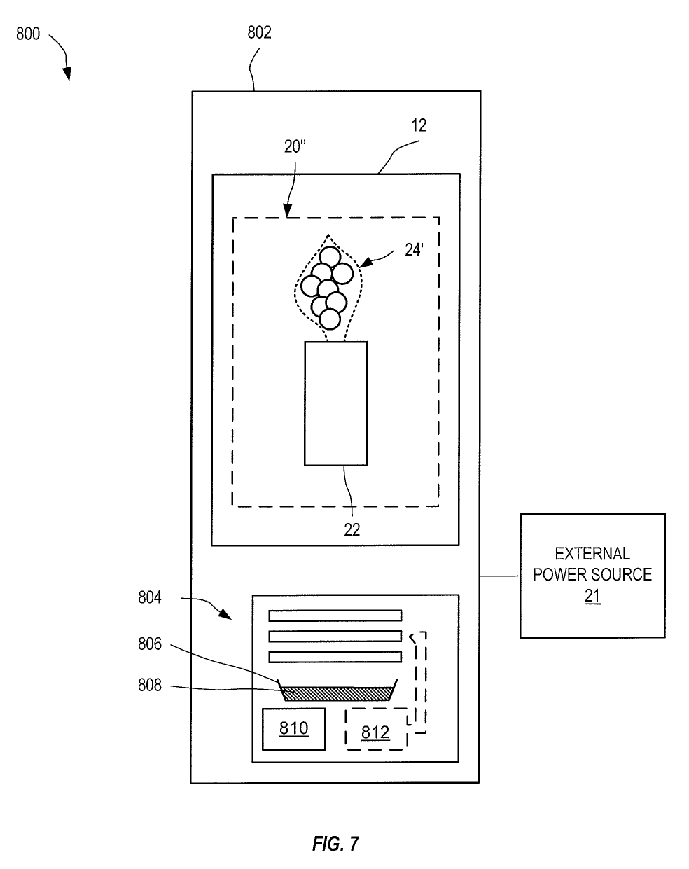

FIG. 7 shows one exemplary scented candle device 800 that includes a frame 802, an LCD panel 12 showing an image 20″ of a candle, similar to that of FIG. 3, and an aroma generator 804 that operates to produce a scented smell, similar to the smell produced by a burning, scented candle. Generator 804 is shown with a partially open oil container 806 filled with an aromatic oil 808 that may be heated by a heater 810 to cause the aroma to be emitted from device 800. Heater 810 may operate with power from battery 19 or with power from power converting electronics 23 and external power source 21. In an embodiment, device 800 includes power pins that plug directly into a household power socket. In another embodiment, oil 808 is encapsulated within a porous medium that allows slow evaporation of oil 808 upon application of heat from heater 810. In yet another embodiment, heater 810 is omitted and oil 808 is periodically vaporized by a pump and atomizing nozzle 812 under microprocessor control.

Although illustratively shown on the front surface of device 800, aroma generator 804 may be positioned on other sides (e.g., rear or side surfaces) of device 800 without departing from the scope hereof.

Since certain changes may be made in the above methods and systems without departing from the scope hereof, it is intended that all matter contained in the above description or shown in the accompanying drawing be interpreted as illustrative and not in a limiting sense. It is also to be understood that the following claims are to cover generic and specific features described herein, and all statements of the scope hereof which, as a matter of language, might be said to fall there between.

What is claimed is:

1. A flickering display system, comprising: a display, a microprocessor, one or more light emitting diodes and digital memory, the memory storing one or more digital images of a lighted candle, wherein, under control of the microprocessor, the display displays the digital images and the diodes activate in a flame area of the candle such that, when viewed, the digital images and diodes appear like a real candle.

2. The system of claim 1, wherein the digital memory comprises FLASH and the digital images are formed via MPEG.

3. The system of claim 2, the MPEG comprising images of a candle that burns down over time, with wax flowing over the candle.

4. The system of claim 1, further comprising a battery to power the display, diodes and memory.

5. The system of claim 1, further comprising power electronics configured to power the display, diodes and memory when connected to residential supply voltage.

6. The system of claim 1, the display comprising a liquid crystal display.

7. The system of claim 1, further comprising a user interface for turning the system on and off.

8. A method for generating an appearance of a candle, comprising:
generating an image of the candle on an LCD display; and
utilizing one or more LEDs to brighten a flame area of the candle.

9. The method of claim 8, the step of generating an image comprising generating a movie with changing features of the candle.

10. The method of claim 8, further comprising modulating the LEDs to provide flicker to the flame area.

11. The method of claim 9, the step of modulating comprising utilizing pixels of the LCD.

12. The method of claim 9, the step of modulating comprising utilizing a polarizer.

13. The method of claim 9, the step of modulating comprising utilizing pixels of the LCD.

14. A scented flickering display system, comprising: a display, a microprocessor, one or more light emitting diodes, an aroma generator and digital memory, the memory storing one or more digital images of a lighted candle, wherein, under control of the microprocessor, the display displays the digital images and the diodes activate in a flame area of the candle such that, when viewed, the digital images and diodes appear like a real candle, and the aroma generator, under control of the microprocessor, generates a scented candle aroma.

15. The system of claim 14, wherein the digital memory comprises FLASH and the digital images are formed via MPEG.

16. The system of claim 15, the MPEG comprising images of a candle that burns down over time, with wax flowing over the candle.

17. The system of claim 14, further comprising power electronics configured to power the display, diodes, aroma generator and memory when connected to residential supply voltage.

18. The system of claim 17, the aroma generator heating an aromatic oil to emit a scent.

19. The system of claim 17, the aroma generator atomizing a liquid scent by pumping the liquid scent through a nozzle.

20. The system of claim 14, further comprising a user interface for turning the system on and off.
